(19) United States
(12) Patent Application Publication
(10) Pub. No.: US 2024/0349384 A1
(43) Pub. Date: Oct. 17, 2024

(54) CONTROL METHOD AND COMMUNICATION DEVICE

(71) Applicant: GUANGDONG OPPO MOBILE TELECOMMUNICATIONS CORP., LTD., Dongguan (CN)

(72) Inventors: Yi HU, Dongguan (CN); Haitao LI, Dongguan (CN)

(73) Assignee: GUANGDONG OPPO MOBILE TELECOMMUNICATIONS CORP., LTD., Dongguan (CN)

(21) Appl. No.: 18/751,318

(22) Filed: Jun. 23, 2024

Related U.S. Application Data
(63) Continuation of application No. PCT/CN2021/141777, filed on Dec. 27, 2021.

(51) Int. Cl. H04W 76/20; H04B 7/06; H04W 52/02; H04W 52/36

(52) U.S. Cl. CPC H04W 76/20; H04B 7/0626; H04W 52/0235; H04W 52/365

(57) ABSTRACT

The present disclosure relates to the field of communications, and more specifically, to a control method, a terminal device, and a network device. The specific implementation comprises: when a terminal device performs state conversion and/or receives an indication for triggering said state conversion, the terminal device controlling at least one of a resource configuration and a timer. The present disclosure can control a relevant configuration when a UE performs state conversion.

### CROSS REFERENCE TO RELATED APPLICATIONS

The present disclosure is a continuation of International Patent Application No. PCT/CN2021/141777, filed on Dec. 27, 2021, the contents of which is herein incorporated by reference in its entirety.

### TECHNICAL FIELD

The present disclosure relates to the field of communication, and in particular to a control method and a communication device.

### BACKGROUND

Traditional energy-saving technologies in a connected state are designed for a terminal main receiver being always in an open state. After introducing an ultra-low power wake up signal (LP-WUS) mechanism, a terminal device starts a main receiver (main radio) to monitor a downlink signal after receiving the LP-WUS, so as to achieve the purpose of energy saving. Therefore, an UE needs to transition between a normal receiving state (e.g., the main receiver is in a normal working state) and a low-power receiving state (e.g., only a LP-WUS receiver is in a working state, and the main receiver is in an off or deep sleep state) according to operational situations. How to control relevant configurations when the UE performs a state transition becomes a technical problem to be solved.

### SUMMARY

The present disclosure provides a control method, including: controlling, by a terminal device, at least one of a resource configuration and a timer, in response to the terminal device performing a state transition and/or receiving an instruction of triggering the state transition, the terminal device performing the state transition includes: the terminal device transitioning from a normal receiving state to a low-power receiving state; and/or the terminal device transitioning from the low-power receiving state to the normal receiving state.

The present disclosure provides a communication device, including: a memory, configured to store a computer program; and a processor, configured to call and perform the computer program stored in the memory, making a terminal device to execute the method mentioned above.

The present disclosure provides a communication device, including: a memory, configured to store a computer program; and a processor, configured to call and perform the computer program stored in the memory, making a network device to execute: sending an instruction of triggering a terminal device to perform a state transition; and controlling at least one of a resource configuration and a timer.

### BRIEF DESCRIPTION OF THE DRAWINGS

FIG. 1 is a schematic diagram of an application scenario according to some embodiments of the present disclosure.

FIG. 2 is a schematic diagram of a working principle of a LP-WUS according to some embodiments of the present disclosure.

FIG. 3 is a schematic flow chart of a control method according to some embodiments of the present disclosure.

FIG. 4 is a schematic diagram of controlling an uplink and downlink transmission in a control method according to some embodiments of the present disclosure.

FIG. 5 is a schematic diagram of controlling an SCell state in a control method according to some embodiments of the present disclosure.

FIG. 6 is a schematic diagram of controlling a data inactivity timer in a control method according to some embodiments of the present disclosure.

FIG. 7 is a schematic flow chart of a control method according to some embodiments of the present disclosure.

FIG. 8 is a structural schematic view of a terminal device according to some embodiments of the present disclosure.

FIG. 9 is a structural schematic view of a network device according to some embodiments of the present disclosure.

FIG. 10 is a structural schematic view of a communication device according to some embodiments of the present disclosure.

FIG. 11 is a structural schematic view of a chip according to some embodiments of the present disclosure.

FIG. 12 is a structural schematic view of a communication system according to some embodiments of the present disclosure.

### DETAILED DESCRIPTION

The technical solutions in the embodiments of the present disclosure will be described below with the drawings in the embodiments of the present disclosure.

The technical solutions in the embodiments of the present disclosure may be applied to various communication systems, for example: global system of mobile communication (GSM) system, code division multiple access (CDMA) system, wideband code division multiple access (WCDMA) system, general packet radio service (GPRS), long term evolution (LTE) system, advanced long term evolution (LTE-A) system, new radio (NR) system, evolution system of NR system, LTE-based access to unlicensed spectrum (LTE-U) system, NR-based access to unlicensed spectrum (NR-U) system, non-terrestrial networks (NTN) system, universal mobile telecommunications system (UMTS), wireless local area networks (WLAN), wireless fidelity (WiFi), fifth-generation (5G) system, or other communication systems.

Generally speaking, the number of connections supported by traditional communication systems is limited and easy to implement. However, with the development of communication technologies, mobile communication systems will not only support traditional communication, but also support communication such as device to device (D2D) communication, machine to machine (M2M) communication, machine type communication (MTC), vehicle to vehicle (V2V) communication, or vehicle to everything (V2X) communication, etc. The embodiments of the present disclosure may also be applied to these communication systems.

The communication system in the embodiments of the present disclosure may be applied to a carrier aggregation (CA) scenario, may also be applied to a dual connectivity (DC) scenario, and may also be applied to a standalone (SA) network deployment scenario.

The communication system in the embodiments of the present disclosure may be applied to an unlicensed spectrum, and the unlicensed spectrum may also be considered as a shared spectrum. Or, the communication system in the embodiments of the present disclosure may also be applied to a licensed spectrum, and the licensed spectrum may also be considered as a non-shared spectrum.

The embodiments of the present disclosure describe various embodiments in conjunction with a network device and a terminal device. The terminal device may also be referred to as an user device (UE), an access terminal, an user unit, an user station, a mobile station, a remote station, a remote terminal, a mobile device, an user terminal, a terminal, a wireless communication device, an user agent, or an user apparatus.

The terminal device can be a station (ST) in the WLAN, and can be a cellular phone, a cordless phone, a session initiation protocol (SIP) phone, a wireless local loop (WLL) station, a personal digital assistant (PDA) device, a handheld device with wireless communication functions, a computing device or other processing devices connected to wireless modems, a vehicle-mounted device, a wearable device, and a next-generation communication system such as a terminal device in a NR network, or a terminal device in a public land mobile network (PLMN) network of future evolution.

In the embodiments of the present disclosure, the terminal device may be deployed on land, including indoor or outdoor, handheld, wearable, or vehicle-mounted; may also be deployed on water (e.g. ships); and may also be deployed in the air (e.g., aircraft, balloons, and satellites).

In the embodiments of the present disclosure, the terminal device may be a mobile phone, a pad, a computer with wireless transceiver functions, a virtual reality (VR) terminal device, an augmented reality (AR) terminal device, a wireless terminal device in industrial control, a wireless terminal device in self driving, a wireless terminal device in remote medical, a wireless terminal device in smart grid, a wireless terminal device in transportation safety, a wireless terminal device in smart city, or a wireless terminal device in smart home.

As an example without limitation, in the embodiments of the present disclosure, the terminal device may also be a wearable device. The wearable device may also be called a wearable smart device, the wearable smart device is a general term of wearable devices that are the application of wearable technologies for intelligent design and development of daily wear, such as glasses, gloves, watches, clothing, and shoes. The wearable device is a portable device that is worn directly on the body or integrated into the user's clothing or accessories. The wearable device is not only a hardware device, but also has powerful functions by software support, data interaction, and cloud interaction. Generalized wearable smart devices include characteristics of full-featured, large-sized, implementing complete or partial functions without relying on smart phones, such as smart watches or smart glasses, and only focusing on a certain type of application functions and need to cooperate with other devices such as smart phones, such as various smart bracelets and smart jewelry for vital signs monitoring.

In the embodiments of the present disclosure, the network device may be a device for communicating with the mobile device, may be an access point (AP) in the WLAN or a base transceiver station (BTS) in the GSM or the CDMA, may also be a NodeB (NB) in the WCDMA, and may also be an evolutional Node B (eNB or eNodeB) in the LTE, a relay station or an access point, or a vehicle-mounted device, a wearable device, and a gNB in the NR network, a network device in the PLMN network of future evolution, or a network device in the NTN network.

As an example without limitation, in the embodiments of the present disclosure, the network device may have a mobile feature, for example, the network device may be a mobile device. The network device may be a satellite or a balloon station. For example, the satellite may be a low earth orbit (LEO) satellite, a medium earth orbit (MEO) satellite, a geostationary earth orbit (GEO) satellite, and a high elliptical orbit (HEO) satellite. The network device may also be a base station installed on land or water.

In the embodiments of the present disclosure, the network device may provide services for a cell, and the terminal device communicates with the network device through transmission resources (such as frequency domain resources or spectrum resources) used by the cell. The cell may be a cell corresponding to the network device (such as a base station), and the cell may belong to a macro base station, or may belong to a base station corresponding to a small cell. The small cell may include a metro cell, a micro cell, a pico cell, a femto cell, etc. The small cell has characteristics of small coverage and low transmission power, and is suitable for providing high-speed data transmission services.

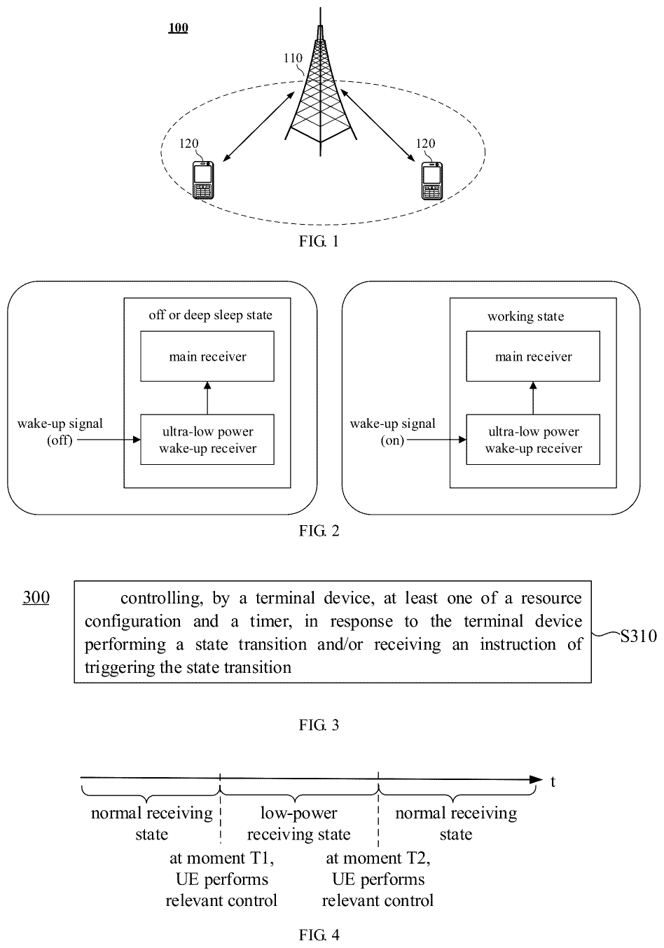

FIG. 1 illustrates a communication system 100. The communication system 100 includes a network device 110 and two terminal devices 120. In some embodiments, the communication system 100 may include multiple network devices 110, and other numbers of terminal devices 120 may within a coverage area of each network device 110, which are not limited in the embodiments of the present disclosure.

In the embodiments of the present disclosure, the communication system 100 may also include other network entities such as a mobility management entity (MME), an access and mobility management function (AMF), etc. The embodiments of the present disclosure is not limited thereto.

The network device may also include an access network device and a core network device. That is, the wireless communication system also includes multiple core networks for communicating with the access network devices. The access network device may be an evolutional node B (eNB or e-NodeB for short), a macro base station, a micro base station (also called a “small base station”), a pico base station, an access point (AP), a transmission point (TP), or a new generation Node B (gNodeB), etc. in the long-term evolution (LTE) system, a next-generation (mobile communication system) (next radio, NR) system, or an authorized auxiliary access long-term evolution (LAA-LTE) system.

It should be understood that a device with communication functions in the network or system in the embodiments of the present disclosure may be referred to as a communication device. Taking the communication system shown in FIG. 1 as an example, the communication device may include a network device and a terminal device with communication functions. The network device and the terminal device may be specific devices in the embodiments of the present disclosure, which are not described here again. The communication device may also include other devices in the communication system, such as network controllers, mobility management entities, and other network entities, which are not limited in the embodiments of the present disclosure.

It should be understood that the terms “system” and “network” are often used interchangeably in the present disclosure. The term “and/or” in the present disclosure is only an association relationship describing associated objects, indicating that there may be three kinds of relationships. For example, A and/or B may indicate that there are three situations: A exists alone, A and B exist simultaneously, and B exists alone. In addition, the character “/” in the present disclosure generally indicates that relationship between a preceding object and a following object of the “/” is the preceding object or the following object.

It should be understood that the “indication” mentioned in the embodiments of the present disclosure may be a direct indication, an indirect indication, or an indication of an association relationship. For example, A indicates B, which may indicate that A directly indicates B, such as B may be obtained through A; may also indicate that A indirectly indicates B, such as A indicates C, and B may be obtained through C; and may also indicate that there is an association relationship between A and B.

In the embodiments of the present disclosure, the term “corresponding” may indicate that there is a direct or indirect corresponding relationship between the two, that there is an association relationship between the two, or that there is a relationship of one may indicate and the other one may be instructed, one may configure and the other one may be configured, etc.

In order to facilitate understanding of the technical solutions in the embodiments of the present disclosure, the relevant technologies in the embodiments of the present disclosure are described below. The following relevant technologies may be combined with the technical solutions in the embodiments of the present disclosure as optional solutions, and all of them fall within the protection scope in the embodiments of the present disclosure.

Traditional energy-saving technologies in a connected state are designed for a main receiver of a terminal device being always in an open state, including a discontinuous reception (DRX) mechanism and a WUS mechanism. An ultra-low power wake up signal (LP-WUS) is currently introduced. Compared with the WUS mechanism, the LP-WUS mechanism is more energy-saving and can use an LP-WUS receiver with ultra-low power. After receiving the LP-WUS, the terminal starts the main receiver to monitor the downlink signal, so as to achieve the purpose of energy saving.

For example, a UE in a radio resource control (RRC) connected state needs to transition between a normal receiving state (e.g., the main receiver is in a normal working state) and a low-power receiving state (e.g., only the LP-WUS receiver is in a working state, while the main receiver is in an off or deep sleep state). Whether the UE needs to perform special operations on the configuration of uplink and downlink transmission and relevant timers in response to the UE performing a state transition, there is no relevant solution yet.

FIG. 2 is a schematic diagram of a working principle of a LP-WUS. As shown in FIG. 2, in response to receiving an indication to enter the low-power receiving state, the UE enters the low-power receiving state. In this case, the LP-WUS receiver is in the working state, and the main receiver is in the off or deep sleep state; In response to receiving the LP-WUS, the UE enters the normal receiving state, and the main receiver enters the working state.

The present disclosure provides a control method, and FIG. 3 is a schematic flow chart of a control method 300 according to some embodiments of the present disclosure. In some embodiments, the method may be applied to a system shown in FIG. 1, but is not limited thereto. The method may include operations executed by the following blocks.

At block S310, a terminal device controls at least one of a resource configuration and a timer, in response to the terminal device performing a state transition and/or receiving an instruction of triggering the state transition.

In some embodiments, the terminal device performing the state transition mentioned above includes the terminal device transitioning from a normal receiving state to a low-power receiving state; and/or the terminal device transitioning from the low-power receiving state to the normal receiving state.

In the embodiments of the present disclosure, the normal receiving state includes a main receiver (main radio) of the terminal device being in a working state.

In the embodiments of the present disclosure, the low-power receiving state includes a low-power receiver of the terminal device being in a working state, and/or the main receiver of the terminal device being in an off state or in a deep sleep state.

In some embodiments, the instruction of triggering the state transition includes at least one of: an instruction of entering the low-power receiving state; and a LP-WUS.

In the embodiments of the present disclosure, in response to receiving the instruction of entering the low-power receiving state, the terminal device may transition from the normal receiving state to the low-power receiving state; in response to receiving the LP-WUS, the terminal device may transition from the low-power receiving state to the normal receiving state.

In the embodiments of the present disclosure, in response to performing the state transition and/or receiving the instruction of triggering the state transition, the terminal device may control at least one of: an uplink and downlink pre-configured grant, a channel state information (CSI) report, a sounding reference signal (SRS), a physical uplink control channel (PUCCH), a power headroom report (PHR), a secondary cell (SCell) state, and a data inactivity timer. In the embodiments of the present disclosure, the terminal device may also control other relevant configurations and timers in response to performing the state transition and/or receiving the instruction of triggering the state transition, which are not exhaustive here.

The control method mentioned above will be described in detail below in conjunction with the accompanying drawings.

FIG. 4 is a schematic diagram of controlling an uplink and downlink transmission in a control method according to some embodiments of the present disclosure. As shown in FIG. 4, the UE receives the instruction of entering the low-power receiving state from the network at a moment T1, and transitions from the normal receiving state (e.g., the main radio is in the working state) to the low-power receiving state (e.g., only the low-power receiver is in the working state, while the main radio is in the off state or in the deep sleep state). Or, the UE transitions from the normal receiving state (e.g., the main radio is in the working state) to the low-power receiving state (e.g., only the low-power receiver is in the working state, while the main radio is in the off state or in the deep sleep state) according to other trigger conditions at the moment T1. In this case, the UE performs at least one of the following controls.

(1) The UE controls the uplink and downlink pre-configured grant, and the UE controlling the uplink and downlink pre-configured grant includes at least one of: suspending a configuration grant (CG) type 1 (type1configured grant); clearing the CG type 1 (type1 CG); clearing or deactivating a semi-persistent scheduling (SPS); and clearing or deactivating a CG type 2 (type2 CG).

(2) The UE controls the CSI report, and the UE controlling the CSI report includes at least one of: suspending or clearing a periodic CSI report; and suspending, clearing, or deactivating a semi-persistent CSI report.

(3) The UE controls the SRS, and the UE controlling the SRS includes at least one of: suspending or clearing a periodic SRS; and suspending, clearing, or deactivating a semi-persistent SRS.

(4) The UE controls the PUCCH, and the UE controlling the PUCCH includes suspending or clearing the physical uplink control channel (PUCCH).

In some embodiments, the PUCCH suspended or cleared may be at least one of: a PUCCH configured for a scheduling request (SR) transmission, a PUCCH configured for a hybrid automatic repeat request (HARQ) acknowledgement (ACK)/non-acknowledgement (NACK) transmission, and a PUCCH configured for the CSI report.

(5) The UE controls the PHR, and the UE controlling the PHR includes stopping or suspending at least one of timers: a PHR periodic timer (phr-Periodic Timer); a PHR prohibit timer (phr-ProhibitTimer); and an MPE prohibit timer (mpe-ProhibitTimer).

In response to the UE performing the control mentioned above, the network device (e.g., the base station) may perform the same control. For example, the network device sends an instruction of triggering the terminal device to transition from the normal receiving state to the low-power receiving state (e.g., sending the instruction of entering the low-power receiving state, which is received by the terminal device at the moment T1), and performs the control mentioned above. The specific control mode may be referred to the control mode of the terminal device mentioned above, which will not be repeated here.

As shown in FIG. 4, the UE receives the LP-WUS from the network at a moment T2, and transitions from the low-power receiving state (e.g., only the low-power receiver is in the working state, while the main radio is in the off state or in the deep sleep state) to the normal receiving state (e.g., the main radio is in the working state). Or, the UE transitions from the low-power receiving state (e.g., only the low-power receiver is in the working state, while the main radio is in the off state or in the deep sleep state) to the normal receiving state (e.g., the main radio is in the working state) according to other trigger conditions at the moment T2. In this case, the UE performs at least one of the following controls.

(1) The UE controls the uplink and downlink pre-configured grant, and the UE controlling the uplink and downlink pre-configured grant includes initializing or recovering a suspended CG type 1 (type 1CG).

For example, when the control performed by the UE on the type 1CG at the moment T1 is to suspend the type1CG, in this case, the UE initializes (or re-initializes) or recovers the suspended type 1CG according to stored configurations.

In some embodiments, the suspended type 1CG being initialized or recovered in the embodiment of the present disclosure is a type1CG configured on a special cell (SpCell) and/or a type 1CG configured on an activated secondary cell (SCell).

(2) The UE controls the CSI report, and the UE controlling the CSI report includes at least one of: initializing or recovering a suspended periodic CSI report; and initializing or recovering a suspended semi-persistent CSI report.

For example, when the control performed by the UE on the periodic CSI report and/or the semi-persistent CSI report at the moment T1 is to suspend the periodic CSI report and/or the semi-persistent CSI report, in this case, the UE may initialize (or re-initialize) or recover the suspended periodic CSI report and/or the semi-persistent CSI report.

(3) The UE controls the SRS, and the UE controlling the SRS includes at least one of: initializing or recovering a suspended periodic SRS; and initializing or recovering a suspended semi-persistent SRS.

For example, when the control performed by the UE on the periodic SRS and/or the semi-persistent SRS at the moment T1 is to suspend the periodic SRS and/or the semi-persistent SRS, in this case, the UE may initialize (or re-initialize) or recover the suspended periodic SRS and/or the semi-persistent SRS according to the stored configurations.

(4) The UE controls the PUCCH, and the UE controlling the PUCCH includes initializing or recovering a suspended PUCCH.

For example, when the control performed by the UE on the PUCCH at the moment T1 is to suspend the PUCCH, in this case, the UE may initialize (or re-initialize) or recover the suspended PUCCH according to the stored configurations.

In some embodiments, the PUCCH mentioned above may be at least one of a PUCCH configured for the SR transmission, a PUCCH configured for the HARQ ACK/NACK transmission, and a PUCCH configured for the CSI report.

(5) The UE controls the PHR, and the UE controlling the PHR includes triggering the PHR and recovering or starting at least one of a PHR periodic timer, a PHR prohibit timer, and a MPE prohibit timer.

For example, when the control performed by the UE on the PHR periodic timer, the PHR prohibit timer, or the MPE prohibit timer at the moment T1 is to suspend the PHR periodic timer, the PHR prohibit timer, or the MPE prohibit timer, in this case, the UE may recover the PHR periodic timer, the PHR prohibit timer, or the MPE prohibit timer to work. When the control performed by the UE on the PHR periodic timer, the PHR prohibit timer, or the MPE prohibit timer at the moment T1 is to stop the PHR periodic timer, the PHR prohibit timer, or the MPE prohibit timer, in this case, the UE may start the PHR periodic timer, the PHR prohibit timer, or the MPE prohibit timer.

In response to the UE performing the control mentioned above, the network device (e.g., the base station) may perform the same control. For example, the network device sends an instruction of triggering the terminal device to transition from the low-power receiving state to the normal receiving state (e.g., sending the LP-WUS, which is received by the terminal device at the moment T2), and performs the control mentioned above. The specific control method may be referred to the control method of the terminal device mentioned above, which will not be repeated here.

FIG. 5 is a schematic diagram of controlling an SCell state in a control method according to some embodiments of the present disclosure.

As shown in FIG. 5, the UE receives the instruction of entering the low-power receiving state from the network at the moment T1, and transitions from the normal receiving state (e.g., the main radio is in the working state) to the low-power receiving state (e.g., only the low-power receiver is in the working state, while the main radio is in the off state or in the deep sleep state). Or, the UE transitions from the normal receiving state (e.g., the main radio is in the working state) to the low-power receiving state (e.g., only the low-power receiver is in the working state, while the main radio is in the off state or in the deep sleep state) according to other trigger conditions at the moment T1. In this case, the UE deactivates the SCells. For example, the UE may deactivate all the SCells.

In response to the UE performing the control mentioned above, the network device (e.g., the base station) may perform the same control. For example, the network device sends an instruction of triggering the terminal device to transition from the normal receiving state to the low-power receiving state (e.g., sending the instruction of entering the low-power receiving state, which is received by the terminal device at the moment T1), and deactivates all the SCells of the UE.

As shown in FIG. 5, the UE receives the LP-WUS from the network at the moment T2, and transitions from the low-power receiving state (e.g., only the low-power receiver is in the working state, while the main radio is in the off state or in the deep sleep state) to the normal receiving state (e.g., the main radio is in the working state). Or, the UE transition from the low-power receiving state (e.g., only the low power receiver is in the working state, while the main radio is in the off state or in the deep sleep state) to the normal receiving state (e.g., the main radio is in working state) according to other trigger conditions at moment T2. In this case, the UE activates all or a part of the SCells.

For how to determine the SCell to be activated (may be referred to as a target SCell), the embodiments provide at least the following two methods.

Method one: a SCell that has transitioned from an activated state to ta deactivated state is referred to as the target SCell, during a latest transition process of the UE from the normal receiving state to the low-power receiving state.

For example, at the moment T1, the UE transitions from the normal receiving state to the low-power receiving state, and deactivates all the SCells of the UE, including a SCell1, a SCell2, and a SCell3. At the moment T2, the UE transitions from the low-power receiving state to the normal receiving state, and a SCell1, a SCell2, and a SCell3 performing a state transition at the moment T1 are the target SCells. In this case, the UE reactivate the target SCells (i.e., the SCell1, the SCell2, and the SCell3).

Method two: the network configures a first initial state for each SCell of the UE through an UE specific signaling, such as RRC signaling, a media access control (MAC) control element (CE), or the LP-WUS. The first initial state may be the activated state or the deactivated state. The UE refers a SCell whose first initial state is the activated state as the target SCell.

Corresponding to the method one mentioned above, in response to transitioning from the low-power receiving state to the normal receiving state and/or receiving the LP-WUS, the UE activates all or a part of the SCells, and the UE activating all or a part of the SCells includes: the UE determining the SCells transitioning from the activated state to the deactivated state during the latest state transition process of the UE; and the UE activating determined SCells.

Corresponding to the method two mentioned above, in response to transitioning from the low-power receiving state to the normal receiving state and/or receiving the LP-WUS, the UE activates all or a part of the SCells, and the UE activating all or a part of the SCells includes: the UE determining to activate all or a part of the SCells according to a first instruction.

The first instruction is carried in at least one of RRC signaling, an MAC CE, and the LP-WUS. The first instruction may carry the first initial state configured for each SCell described in the method two mentioned above. For example, in response to transitioning from the low-power receiving state to the normal receiving state and/or receiving the LP-WUS, the UE activates the SCell whose first initial state is the activated state indicated in the first instruction.

In response to the UE performing the control mentioned above, the network device (e.g., the base station) may perform the same control. The network device sends the instruction of triggering the terminal device to transition from the low-power receiving state to the normal receiving state (e.g., sending the LP-WUS, which is received by the terminal device at the moment T2), and performs the control mentioned above. The specific control method may be referred to the control method of the terminal device mentioned above, which will not be repeated here.

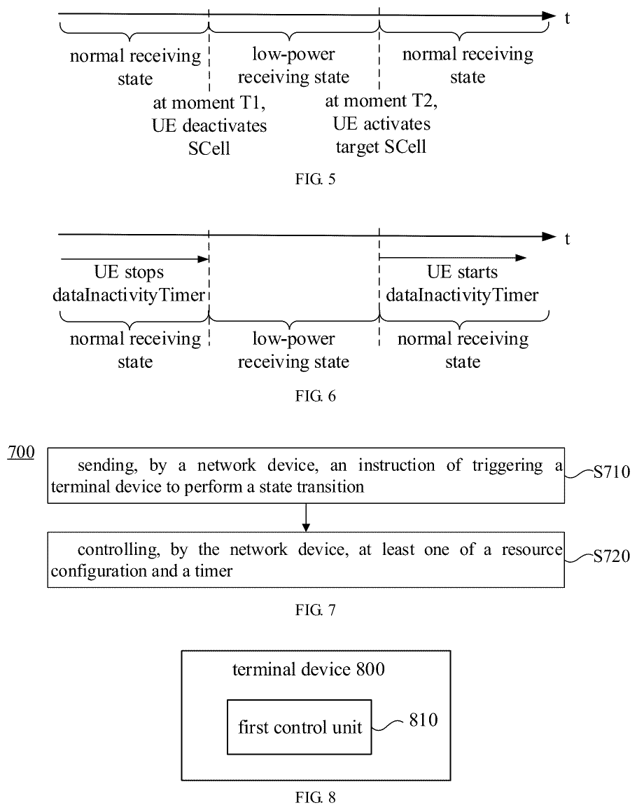

FIG. 6 is a schematic diagram of controlling a data inactivity timer in a control method according to some embodiments of the present disclosure.

As shown in FIG. 6, the UE receives the instruction of entering the low-power receiving state from the network at the moment T1, and transitions from the normal receiving state (e.g., the main radio is in the working state) to the low-power receiving state (e.g., only the low-power receiver is in the working state, while the main radio is in the off state or in the deep sleep state). Or, the UE transitions from the normal receiving state (e.g., the main radio is in the working state) to the low-power receiving state (e.g., only the low-power receiver is in the working state, while the main radio is in the off state or in the deep sleep state) according to other trigger conditions at the moment T1. In this case, the UE controls the data inactivity timer, such as stopping the data inactivity timer (dataInactivityTimer).

In response to the UE performing the control mentioned above, the network device (e.g., the base station) may perform the same control. For example, the network device sends the instruction of triggering the terminal device to transition from the normal receiving state to the low-power receiving state (e.g., sending the instruction of entering the low-power receiving state, which is received by the terminal device at the moment T1), and stops the data inactivity timer (dataInactivityTimer).

As shown in FIG. 6, the UE receives the LP-WUS from the network at the moment T2, and transitions from the low-power receiving state (e.g., only the low-power receiver is in the working state, while the main radio is in the off state or in the deep sleep state) to the normal receiving state (e.g., the main radio is in the working state). Or, the UE transitions from the low-power receiving state (e.g., only the low-power receiver is in the working state, while the main radio is in the off state or in the deep sleep state) to the normal receiving state (e.g., the main radio is in the working state) according to other trigger conditions at the moment T2. In this case, the UE controls the data inactivity timer, such as starting (or restarting) the data inactivity timer (dataInactivityTimer).

In response to the UE performing the control mentioned above, the network device (e.g., the base station) may perform the same control. The network device sends the instruction of triggering the terminal device to transition from the low-power receiving state to the normal receiving state (e.g., sending the LP-WUS, which is received by the terminal device at the moment T2), and starts (or restarts) the data inactivity timer (dataInactivityTimer).

In the embodiments mentioned above, the UE may receive the instruction of entering the low-power receiving state and/or transition from the normal receiving state to the low-power receiving state in response to the UE being in the RRC connected state. Or, the UE may receive the instruction of entering the low-power receiving state and/or transition from the normal receiving state to the low-power receiving state in response to the UE being in the RRC inactive state or the RRC idle state. The network device may send the instruction of entering the low-power receiving state or other instructions to trigger the terminal device to perform the state transition to a terminal device in the RRC connected state, the RRC inactive state, or the RRC idle state, so as to trigger the UE to transition from the normal receiving state to the low-power receiving state.

In summary, the present disclosure provides a control method for a terminal supporting the low-power receiver to process a network instruction message. The control method at least includes: in response to the UE transitioning from the normal receiving state to the low-power receiving state, the UE clears or suspends the uplink/downlink transmission configuration, and stops or suspends timers relevant to the PHR; in response to the UE transitioning from the low-power receiving state to the normal receiving state, the UE recovers the suspended uplink/downlink transmission configuration, recovers the suspended timer, and triggers the PHR. In response to the UE transitioning from the normal receiving state to the low-power receiving state, the UE deactivates all the SCells; in response to the UE transitioning from the low-power receiving state to the normal receiving state, the UE automatically activates all or a part of the SCells. In response to the UE transitioning from the normal receiving state to the low-power receiving state, the UE stops the dataInactivityTimer; in response to the UE transitioning from the low-power receiving state to the normal receiving state, the UE starts the dataInactivity Timer. Therefore, the present disclosure implements the control of relevant configurations in response to the UE performing the state transition.

The embodiments of the present disclosure also provide another control method, which may be applied to a network device. FIG. 7 is a schematic flow chart of a control method 700 according to some embodiments of the present disclosure. In some embodiments, the method may be applied to the system shown in FIG. 1, but is not limited thereto. The method may include operations executed by the following blocks.

At block S710, the network device sends an instruction of triggering a terminal device to perform a state transition.

At block S720, the network device controls at least one of a resource configuration and a timer.

In some embodiments, the instruction of triggering the state transition mentioned above includes at least one of: an instruction of entering the low-power receiving state; and a LP-WUS.

In some embodiments, the instruction of entering the low-power receiving state is configured to trigger the terminal device to transition from a normal receiving state to a low-power receiving state. The LP-WUS mentioned above is configured to trigger the terminal device to transition from the low-power receiving state to the normal receiving state.

In some embodiments, the normal receiving state mentioned above includes a main receiver of the terminal device being in a working state.

In some embodiments, the low-power receiving state mentioned above includes a low-power receiver of the terminal device being in a working state, and/or the main receiver of the terminal device being in an off state or in a deep sleep state.

The method in which the network device controls at least one of the resource configuration and the timer is the same as the method described in the foregoing embodiments of the terminal device. For example, the network device controls at least one of the uplink and downlink pre-configured grant, the CSI report, the SRS, the PUCCH, the PHR, the SCell state, and the data inactivity timer.

For example, in response to the network device sending the instruction of entering the low-power receiving state, the network device controls the uplink and downlink pre-configured grant, and the network device controlling the uplink and downlink pre-configured grant includes at least one of: suspending the CG type 1; clearing the CG type 1; clearing or deactivating the SPS; clearing or deactivating the CG type 2.

In response to the network device sending the instruction of entering the low-power receiving state, the network device controls the CSI report, and the network device controlling the CSI report includes at least one of: suspending or clearing the periodic CSI report; and suspending, clearing, or deactivating the semi-persistent CSI report.

In response to the network device sending the instruction of entering the low-power receiving state, the network device controls the SRS, and the network device controlling the SRS includes at least one of: suspending or clearing the periodic SRS; and suspending, clearing, or deactivating the semi-persistent SRS.

In response to the network device sending an instruction of entering the low-power receiving state, the network device controls the PUCCH, and the network device controlling the PUCCH includes suspending or clearing the PUCCH.

In some embodiments, the suspended or cleared PUCCH may be at least one of the PUCCH configured for the SR transmission, the PUCCH configured for the HARQ ACK/NACK transmission, and the PUCCH configured for the CSI report.

In response to the network device sending the instruction of entering the low-power receiving state, the network device controls the PHR, and the network device controlling the PHR including stopping or suspending at least one of the PHR periodic timer, the PHR prohibit timer, and the MPE prohibit timer.

In responses to the network device sending the instruction of entering the low-power receiving state, the network device controls the SCell state, and the network device controlling the SCell state includes deactivating the SCell.

In response to the network device sending the instruction of entering the low-power receiving state, the network device controls the data inactivity timer, and the network device controlling the data inactivity timer includes stopping the data inactivity timer.

In response to the network device sending the LP-WUS, the network device controls the uplink and downlink pre-configured grant, and the network device controlling the uplink and downlink pre-configured grant includes initializing or recovering the suspended CG type 1.

The suspended CG type 1 may be the CG type 1 configured on the SpCell and/or the CG type 1 configured on the activated Scell.

In response to the network device sending the LP-WUS, the network device controls the CSI report, and the network device controls the CSI report includes at least one of: initializing or recovering the suspended periodic CSI report; and initializing or recovering the suspended semi-persistent CSI report.

In response to the network device sending the LP-WUS, the network device controls the SRS, and the network device controlling the SRS includes at least one of: initializing or recovering the suspended periodic SRS; and initializing or recovering the suspended semi-persistent SRS.

In response to the network device sending the LP-WUS, the network device controls the PUCCH, and the network device controlling the PUCCH includes initializing or recovering the suspended PUCCH.

In some embodiments, the PUCCH mentioned above may be at least one of the PUCCH configured for SR transmission, the PUCCH configured for HARQ ACK/NACK transmission, and the PUCCH configured for CSI report.

In response to the network device sending the LP-WUS, the network device controls the PHR, and the network device controlling the PHR includes: triggering the PHR; and recovering or starting at least one of the PHR periodic timer, the PHR prohibit timer, and the MPE prohibit timer.

In response to the network device sending the LP-WUS, the network device controls the SCell state, and the network device controlling the SCell state including activating all or a part of the SCells.

The network device activating all or a part of the SCells may include: the network device determining the SCells transitioning from the activated state to the deactivated state during the latest state transition process of the terminal device; and the network device activating the determined SCells.

The network device activating all or a part of the SCells may include: the network device determining to activate all or a part of the SCells according to the first instruction sent to the terminal device.

The first instruction mentioned above may be carried in at least one of RRC signaling, the MAC CE, and the LP-WUS.

All or a part of the SCells determined to be activated by the network device may be referred to as the target SCells. The first instruction may carry the first initial state configured by the network device for each SCell of the terminal device. For example, the network device may configure the first initial state for each SCell of the UE through the UE specific signaling, such as the RRC signaling, the media access control (MAC) control element (CE), or the LP-WUS. The first initial state may be the activated state or the deactivated state. In response to the UE transitioning from the low-power receiving state to the normal receiving state, both the UE and the network device take the SCell whose first initial state is the activated state as the target SCell, and activate the target SCell.

In response to the network device sending the LP-WUS, the network device controls the data inactivity timer, and the network device controlling the data inactivity timer includes: starting the data inactivity timer.

In some embodiments, the network device may send the instruction of entering the low-power receiving state to the terminal device in the RRC connected state, the RRC inactive state, or the RRC idle state, to trigger the terminal device to transition from the normal receiving state to the low-power receiving state.

The control performed by the network device in response to the network device sending the instruction of entering the low-power receiving state is the same as the control performed by the terminal device in response to the terminal device receiving the instruction to entering the low-power receiving state in the above embodiments. The control performed by the network device in response to the network device sending the LP-WUS is the same as the control performed by the terminal device in response to the terminal device receiving the LP-WUS in the above embodiments. In this way, the network device and the terminal device may control relevant configurations such as the resource configuration and the timer in response to the UE performing the state transition.

FIG. 8 is a structural schematic view of a terminal device 800 according to some embodiments of the present disclosure. The terminal device 800 may include a first control unit 810 configured to control at least one of the resource configuration and the timer in response to the terminal device performing the state transition and/or receiving the instruction of triggering the state transition.

In some embodiments, the terminal device performing the state transition includes: the terminal device transitioning from the normal receiving state to the low-power receiving state; and/or the terminal device transitioning from the low-power receiving state to the normal receiving state.

In some embodiments, the normal receiving state includes the main receiver of the terminal device being in the working state.

In some embodiments, the low-power receiving state includes the low-power receiver of the terminal device being in the working state, and/or the main receiver of the terminal device being in the off state or in the deep sleep state.

In some embodiments, the instruction of triggering the state transition includes at least one of: the instruction of entering the low-power receiving state; and the ultra-low power wake-up signal (LP-WUS).

In some embodiments, in response to the terminal device transitioning from the normal receiving state to the low-power receiving state and/or receiving the instruction of entering the low-power receiving state, the first control unit 810 controls at least one of the uplink and downlink pre-configured grant, the CSI report, the SRS, the PUCCH, the PHR, the SCell state, and the data inactivity timer.

In some embodiments, the first control unit 810 controlling the uplink and downlink pre-configured grant includes at least one of: suspending the configured grant (CG) type 1; clearing the CG type 1; clearing or deactivating the SPS; and clearing or deactivating the CG type 2.

In some embodiments, the first control unit 810 controlling CSI report includes at least one of: suspending or clearing the periodic CSI report; and suspending, clearing, or deactivating the semi-persistent CSI report.

In some embodiments, the first control unit 810 controlling the SRS includes at least one of: suspending or clearing the periodic SRS; and suspending, clearing, or deactivating the semi-persistent SRS.

In some embodiments, the first control unit 810 controlling the PUCCH includes suspending or clearing the PUCCH.

In some embodiments, the PUCCH may be at least one of the PUCCH configured for SR transmission, the PUCCH configured for HARQ ACK/NACK transmission, and the PUCCH configured for the CSI report.

In some embodiments, the first control unit 810 controlling the PHR includes: stopping or suspending at least one of the PHR periodic timer, the PHR prohibit timer, and the MPE prohibit timer.

In some embodiments, the first control unit 810 controlling the SCell state includes deactivating the SCell.

In some embodiments, the first control unit 810 controlling the data inactivity timer includes stopping the data inactivity timer.

In some embodiments, in response to the terminal device transitioning from the low-power receiving state to the normal receiving state and/or receiving the LP-WUS, the first control unit 810 controls at least one of the uplink and downlink pre-configured grant, the CSI report, the SRS, the PUCCH, the PHR, the SCell state, and the data inactivity timer.

In some embodiments, the first control unit 810 controlling the uplink and downlink pre-configured grant includes initializing or recovering the suspended CG type 1.

In some embodiments, the suspended CG type 1 is the CG type 1 configured on the SpCell and/or the CG type 1 configured on the activated Scell.

In some embodiments, the first control unit 810 controlling the CSI report includes at least one of: initializing or recovering the suspended periodic CSI report; and initializing or recovering the suspended semi-persistent CSI report.

In some embodiments, the first control unit 810 controlling the SRS includes at least one of: initializing or recovering the suspended periodic SRS; and initializing or recovering the suspended semi-persistent SRS.

In some embodiments, the first control unit 810 controlling the PUCCH includes initializing or recovering the suspended PUCCH.

In some embodiments, the PUCCH may be at least one of the PUCCH configured for SR transmission, the PUCCH configured for HARQ ACK/NACK transmission, and the PUCCH configured for CSI report.

In some embodiments, the first control unit 810 controlling the PHR includes: triggering the PHR; and recovering or starting at least one of the PHR periodic timer, the PHR prohibit timer, and the MPE prohibit timer.

In some embodiments, the first control unit 810 controlling the SCell state includes: activating all or a part of the SCells.

In some embodiments, the first control unit 810 activating all or a part of the SCells includes: determining the SCells transitioning from the activated state to the deactivated state during the latest state transition process of the terminal device; and activating the determined SCells.

In some embodiments, the first control unit 810 activating all or a part of the SCells includes determining to activate all or a part of the SCells according to the first instruction.

In some embodiments, the first instruction is carried in at least one of the RRC signaling, the MAC CE, and the LP-WUS.

In some embodiments, the first control unit 810 controlling the data inactivity timer includes starting the data inactivity timer.

In some embodiments, the terminal device transitioning from the normal receiving state to the low-power receiving state includes: the terminal device transitioning from the normal receiving state to the low-power receiving state in response to the terminal device being in the RRC connected state, the RRC inactive state, or the RRC idle state.

In some embodiments, the terminal device receives the instruction of entering the low-power receiving state in response to the terminal device being in the RRC connected state, the RRC inactive state, or the RRC idle state.

The terminal device 800 in the embodiments of the present disclosure may implement the corresponding functions of the terminal device in the foregoing method embodiments. The processes, functions, implementation methods, and beneficial effects corresponding to each module (a sub-module, an unit, or a component, etc.) of the terminal device 800 may be described in the corresponding description in the foregoing method embodiments, and are not repeated here. It should be noted that the functions of each module (the sub-module, the unit, or the component, etc.) of the terminal device 800 described in the embodiments of the present disclosure may be implemented by different modules (sub-modules, units, or components, etc.), or by the same module (a sub-module, an unit, or a component, etc.).

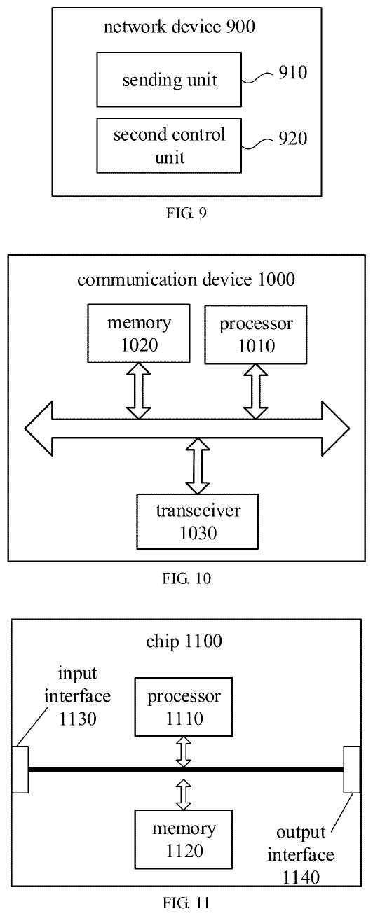

FIG. 9 is a structural schematic view of a network device 900 according to some embodiments of the present disclosure. The network device 900 may include a sending unit 910 configured to send the instruction of triggering the terminal device to perform the state transition, and a second control unit 920 configured to control at least one of the resource configuration and the timer.

In some embodiments, the instruction of triggering the terminal device to perform the state transition includes at least one of: the instruction of entering the low-power receiving state; and the LP-WUS.

In some embodiments, the instruction of entering the low-power receiving state is configured to trigger the terminal device to transition from the normal receiving state to the low-power receiving state.

In some embodiments, the LP-WUS is configured to trigger the terminal device to transition from the low-power receiving state to the normal receiving state.

In some embodiments, the normal receiving state includes the main receiver of the terminal device being in the working state.

In some embodiments, the low-power receiving state includes the low-power receiver of the terminal device being in the working state, and/or the main receiver of the terminal device being in the off state or in the deep sleep state.

In some embodiments, the second control unit 920 is configured to control at least one of the uplink and downlink pre-configured grant, the CSI report, the SRS, the PUCCH, the PHR, the SCell state, and the data inactivity timer.

In some embodiments, in response to the sending unit 910 sending the instruction of entering the low-power receiving state, the second control unit 920 controlling the uplink and downlink pre-configured grant includes at least one of: suspending the configured grant (CG) type 1; clearing the CG type 1; clearing or deactivating the SPS; and clearing or deactivating the CG type 2.

In some embodiments, in response to the sending unit 910 sending the instruction of entering the low-power receiving state, the second control unit 910 controlling CSI report includes at least one of: suspending or clearing the periodic CSI report; and suspending, clearing, or deactivating the semi-persistent CSI report.

In some embodiments, in response to the sending unit 910 sending the instruction of entering the low-power receiving state, the second control unit 920 controlling the SRS includes at least one of: suspending or clearing the periodic SRS; suspending, clearing, or deactivating the semi-persistent SRS.

In some embodiments, in response to the sending unit 910 sending the instruction of entering the low-power receiving state, the second control unit 920 controlling the PUCCH includes suspending or clearing the PUCCH.

In some embodiments, the PUCCH may be at least one of the PUCCH configured for SR transmission, the PUCCH configured for HARQ ACK/NACK transmission, and the PUCCH configured for the CSI report.

In some embodiments, in response to the sending unit 910 sending the instruction of entering the low-power receiving state, the second control unit 920 controlling the PHR includes: stopping or suspending at least one of the PHR periodic timer, the PHR prohibit timer, and the MPE prohibit timer.

In some embodiments, in response to the sending unit 910 sending the instruction of entering the low-power receiving state, the second control unit 920 controlling the SCell state includes: deactivating the SCell.

In some embodiments, in response to the sending unit 910 sending the instruction of entering the low-power receiving state, the second control unit 920 controlling the data inactivity timer includes stopping the data inactivity timer.

In some embodiments, in response to the sending unit 910 sending the LP-WUS, the second control unit 920 controlling the uplink and downlink pre-configured grant includes initializing or recovering the suspended CG type 1.

In some embodiments, the suspended CG type 1 is the CG type 1 configured on the SpCell and/or the CG type 1 configured on the activated Scell.

In some embodiments, in response to the sending unit 910 sending the LP-WUS, the second control unit 920 controlling the CSI report includes at least one of: initializing or recovering the suspended periodic CSI report; and initializing or recovering the suspended semi-persistent CSI report.

In some embodiments, in response to the sending unit 910 sending the LP-WUS, the second control unit 920 controlling the SRS includes at least one of: initializing or recovering the suspended periodic SRS; and initializing or recovering the suspended semi-persistent SRS.

In some embodiments, in response to the sending unit 910 sending the LP-WUS, the second control unit 920 controlling the PUCCH includes: initializing or recovering the suspended PUCCH.

In some embodiments, the PUCCH may be at least one of the PUCCH configured for SR transmission, the PUCCH configured for HARQ ACK/NACK transmission, and the PUCCH configured for the CSI report.

In some embodiments, in response to the sending unit 910 sending the LP-WUS, the second control unit 920 controlling the PHR includes triggering the PHR; and recovering or starting at least one of the PHR periodic timer, the PHR prohibit timer, and the MPE prohibit timer.

In some embodiments, in response to the sending unit 910 sending the LP-WUS, the second control unit 920 controlling the SCell state includes activating all or a part of the SCells.

In some embodiments, the second control unit 920 activating all or a part of the SCells includes: determining the SCells transitioning from the activated state to the deactivated state during the latest state transition process of the terminal device; and activating the determined SCells.

In some embodiments, the second control unit 920 activating all or a part of the SCells includes: the second control unit 920 determining to activate all or a part of the SCells according to the first instruction sent to the terminal device.

In some embodiments, the first instruction is carried in at least one of RRC signaling, the MAC CE, and the LP-WUS.

In some embodiments, in response to the sending unit 910 sending the LP-WUS, the second control unit 920 controlling the data inactivity timer includes starting the data inactivity timer.

In some embodiments, the sending unit 910 sending the instruction of entering the low-power receiving state includes: the sending unit 910 sending the instruction of entering the low-power receiving state to the terminal device in the RRC connected state, the RRC inactive state, or the RRC idle state.

The network device 900 in the embodiments of the present disclosure may implement the corresponding functions of the network device in the foregoing method embodiments. The processes, functions, implementation methods, and beneficial effects corresponding to each module (a sub-module, an unit, or a component, etc.) of the network device 900 may be described in the corresponding description in the foregoing method embodiments, and are not repeated here. It should be noted that the functions of each module (the sub-module, the units, or the component, etc.) of the network device 900 in the embodiments of the present disclosure may be implemented by different modules (sub-modules, units, or components, etc.), or by the same module (a sub-module, an unit, or a component, etc.).

FIG. 10 is a structural schematic view of a communication device 1000 according to some embodiments of the present disclosure. The communication device 1000 includes a processor 1010, and the processor 1010 may call and perform a computer program from a memory, so that the communication device 1000 implements the method in the embodiments of the present disclosure.

In some embodiments, the communication device 1000 may further include a memory 1020. The processor 1010 may call and perform a computer program from the memory 1020, so that the communication device 1000 implements the method in the embodiments of the present disclosure.

The memory 1020 may be an independent device independent of the processor 1010, or may be integrated in the processor 1010.

In some embodiments, the communication device 1000 may further include a transceiver 1030, and the processor 1010 may control the transceiver 1030 to communicate with other devices, such as sending information or data to other devices, or receiving information or data sent by other devices.

The transceiver 1030 may include a transmitter and a receiver. The transceiver 1030 may further include antennas, and the number of the antennas may be one or more.

In some embodiments, the communication device 1000 may be the network device in the embodiments of the present disclosure, and the communication device 1000 may implement the corresponding processes implemented by the network device in each method in the embodiments of the present disclosure, which are not repeated here for brevity.

In some embodiments, the communication device 1000 may be the terminal device in the embodiments of the present disclosure, and the communication device 1000 may implement the corresponding processes implemented by the terminal device in each method of the embodiments of the present disclosure, which are not repeated here for brevity.

FIG. 11 is a structural schematic view of a chip 1100 according to some embodiments of the present disclosure. The chip 1100 includes a processor 1110, and the processor 1110 may call and perform a computer program from a memory, so as to implement the method in the embodiments of the present disclosure.

In some embodiments, the chip 1100 may further include a memory 1120. The processor 1110 may call and perform a computer program from the memory 1120, so as to implement the method executed by the terminal device or the network device in the embodiments of the present disclosure.

The memory 1120 may be an independent device independent of the processor 1110, or may be integrated in the processor 1110.

In some embodiments, the chip 1100 may further include an input interface 1130. The processor 1110 may control the input interface 1130 to communicate with other devices or chips, such as obtaining information or data sent by other devices or chips.

In some embodiments, the chip 1100 may further include an output interface 1140. The processor 1110 may control the output interface 1140 to communicate with other devices or chips, such as outputting information or data to other devices or chips.

In some embodiments, the chip 1100 may be applied to the network device in the embodiments of the present disclosure, and the chip 1100 may implement the corresponding processes implemented by the network device in each method in the embodiments of the present disclosure, which are not repeated here for brevity.

In some embodiments, the chip 1100 may be applied to the terminal device in the embodiments of the present disclosure, and the chip 1100 may implement the corresponding processes implemented by the terminal device in each method of the embodiments of the present disclosure, which are not repeated here for brevity.

The chips applied to the network device and the terminal device may be the same chip or different chips.

It should be understood that the chip mentioned in the embodiments of the present disclosure may also be called a system-on-chip.

The processor mentioned above may be a general-purpose processor, a digital signal processor (DSP), an field programmable gate array (FPGA), an application specific integrated circuit (ASIC), or other programmable logic devices, transistor logic devices, discrete hardware components, etc. The general-purpose processor mentioned above may be a microprocessor or any conventional processor, etc.

The memory mentioned above may be a volatile memory or a nonvolatile memory, or may include both the volatile and nonvolatile memory. The non-volatile memory may be a read-only memory (ROM), a programmable ROM (PROM), an erasable PROM (EPROM), an electrically EPROM (EEPROM), or a flash memory. The volatile memory may be a random access memory (RAM).

It should be understood that the memory mentioned above is illustrative but not restrictive. For example, the memory in the embodiments of the present disclosure may also be a static RAM (SRAM), a dynamic RAM (DRAM), a synchronous DRAM (SDRAM), a double data rate SDRAM (DDR SDRAM), an enhanced SDRAM (ESDRAM), a synch link DRAM (SLDRAM), and a direct rambus RAM (DR RAM), etc. That is, the memory in the embodiments of the present disclosure is intended to include, but not be limited to, these and any other suitable types of memory.

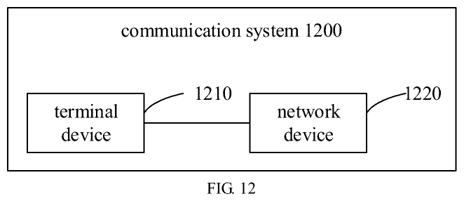

FIG. 12 is a structural schematic view of a communication system 1200 according to some embodiments of the present disclosure. The communication system 1200 includes a terminal device 1210 and a network device 1220.

The terminal device 1210 may be configured to implement the corresponding functions implemented by the terminal device in the above method, and the network device 1220 may be configured to implement the corresponding functions implemented by the network device in the above method, which are not repeated here for brevity.

In the embodiments, all or a part of the embodiments may be implemented by software, hardware, firmware, or any combination thereof. In response to being implemented using software, all or a part of the embodiments may be implemented in the form of a computer program product. The computer program product includes one or more computer instructions. In response to the computer program instructions being loaded and executed on the computer, the processes or functions according to the embodiments of the present disclosure will be generated in whole or in part. The computer may be a general-purpose computer, a special purpose computer, a computer network, or other programmable device. The computer instructions may be stored in a computer-readable storage medium, or transmitted from one computer-readable storage medium to another computer-readable storage medium. For example, the computer instructions may be transferred from one web site, computer, server, or data center to another web site, computer, server, or data center through wired (e.g., a coaxial cable, an optical fiber, a digital subscriber line (DSL)) or wireless (e.g., infrared, wireless, microwave, etc.) means. The computer-readable storage medium may be any available medium that can be accessed by a computer, or a data storage device such as a server or a data center with one or more available media integrated. The available medium may be a magnetic medium (e.g., a floppy disk, a hard disk, or a magnetic tape), an optical medium (e.g., a DVD), or a semiconductor medium (e.g., a solid state disk (SSD)), etc.

It should be understood that, in various embodiments of the present disclosure, the size of the sequence numbers of each process mentioned above does not mean the sequence of execution, and the execution sequence of each process should be determined by functions and internal logic of the process, and should not constitute any limitation on the implementation process in the embodiments of the present disclosure.

Those skilled in the art can clearly understand that for convenience and brevity of the description, specific working processes of the system, device and unit mentioned above may refer to corresponding processes in the foregoing method embodiments, which will not be repeated here.

The description is only specific embodiments of the present disclosure, but the protection scope of the present disclosure is not limited thereto. Any skilled in the art may easily think of changes or substitutions within the technical scope disclosed in the present disclosure, and should be covered within the protection scope of the present disclosure. Therefore, the protection scope of the present disclosure should be based on the protection scope of the claims.

What is claimed is:

1. A control method, comprising:
controlling, by a terminal device, at least one of a resource configuration and a timer, in response to the terminal device performing a state transition and/or receiving an instruction of triggering the state transition;
wherein the terminal device performing the state transition comprises:
the terminal device transitioning from a normal receiving state to a low-power receiving state; and/or
the terminal device transitioning from the low-power receiving state to the normal receiving state.

2. The method according to claim 1, wherein the normal receiving state comprises a main receiver of the terminal device being in a working state.

3. The method according to claim 1, wherein the low-power receiving state comprises a low-power receiver of the terminal device being in a working state, and/or a main receiver of the terminal device being in an off state or in a deep sleep state.

4. The method according to claim 1, wherein the instruction of triggering the state transition comprises at least one of:
an instruction of entering the low-power receiving state; and
an ultra-low power wake-up signal (LP-WUS).

5. The method according to claim 4, wherein in response to the terminal device transitioning from the normal receiving state to the low-power receiving state and/or receiving the instruction of entering the low-power receiving state, the terminal device controls at least one of:
an uplink and downlink pre-configured grant;
a channel state information (CSI) report;
a sounding reference signal (SRS);
a physical uplink control channel (PUCCH);
a power headroom report (PHR);
a secondary cell (SCell) state; and
a data inactivity timer;
the terminal device controlling the uplink and downlink pre-configured grant comprises at least one of:
suspending a configured grant (CG) type 1;
clearing the CG type 1;
clearing or deactivating a semi-persistent scheduling (SPS); and
clearing or deactivating a CG type 2;
the terminal device controlling the CSI report comprises at least one of:
suspending or clearing a periodic CSI report; and
suspending, clearing, or deactivating a semi-persistent CSI report;
the terminal device controlling the SRS comprises at least one of:
suspending or clearing a periodic SRS; and
suspending, clearing, or deactivating a semi-persistent SRS;
the terminal device controlling the PUCCH comprises:
suspending or clearing the PUCCH;
the terminal device controlling the PHR comprises:
stopping or suspending at least one of:
a PHR periodic timer;
a PHR prohibit timer; and
a maximum permissible exposure (MPE) prohibit timer;
the terminal device controlling the SCell state comprises:
deactivating a SCell;
the terminal device controlling the data inactivity timer comprises:
stopping the data inactivity timer.

6. The method according to claim 4, wherein in response to the terminal device transitioning from the low-power receiving state to the normal receiving state and/or receiving the LP-WUS, the terminal device controls at least one of:
an uplink and downlink pre-configured grant;
a CSI report;
a SRS;
a PUCCH;
a PHR;
a SCell state; and
a data inactivity timer;
the terminal device controlling the uplink and downlink pre-configured grant comprises:
initializing or recovering a suspended CG type 1; the suspended CG type 1 is a CG type 1 configured on a special cell (SpCell) and/or a CG type 1 configured on an activated Scell;
the terminal device controlling the CSI report comprises at least one of:
initializing or recovering a suspended periodic CSI report; and
initializing or recovering a suspended semi-persistent CSI report;
the terminal device controlling the SRS comprises at least one of:
initializing or recovering a suspended periodic SRS; and
initializing or recovering a suspended semi-persistent SRS;
the terminal device controlling the PUCCH comprises:
initializing or recovering a suspended PUCCH;
the terminal device controlling the PHR comprises:
triggering the PHR; and
recovering or starting at least one of:
a PHR periodic timer;
a PHR prohibit timer; and
an MPE prohibit timer;
the terminal device controlling the SCell state comprises:
activating all or a part of SCells;
the terminal device controlling the data inactivity timer comprises:
starting the data inactivity timer.

7. The method according to claim 6, wherein the terminal device activating all or a part of the SCells comprises:
the terminal device determining SCells transitioning from an activated state to a deactivated state during a latest state transition process of the terminal device; and
the terminal device activating determined SCells;
or,
the terminal device determining to activate all or a part of the SCells according to a first instruction.

8. The method according to claim 7, wherein the first instruction is carried in at least one of:
RRC signaling;
a medium access control element (MAC CE); and
a LP-WUS.

9. The method according to claim 1, wherein the terminal device transitioning from the normal receiving state to the low-power receiving state comprises:
the terminal device transitioning from the normal receiving state to the low-power receiving state in response to the terminal device being in a radio resource control (RRC) connected state, an RRC inactive state, or an RRC idle state.

10. The method according to claim 4, wherein the terminal device receives the instruction of entering the low-power receiving state in response to the terminal device being in an RRC connected state, an RRC inactive state, or an RRC idle state.

11. A communication device, comprising:
a memory, configured to store a computer program; and
a processor, configured to call and perform the computer program stored in the memory, making a terminal device to execute:
controlling at least one of a resource configuration and a timer, in response to the terminal device performing a state transition and/or receiving an instruction of triggering the state transition;
wherein the terminal device performing the state transition comprises:
the terminal device transitioning from a normal receiving state to a low-power receiving state; and/or
the terminal device transitioning from the low-power receiving state to the normal receiving state.

12. The communication device according to claim 11, wherein the normal receiving state comprises a main receiver of the terminal device being in a working state.

13. The communication device according to claim 11, wherein the low-power receiving state comprises a low-power receiver of the terminal device being in a working state, and/or a main receiver of the terminal device being in an off state or in a deep sleep state.

14. The communication device according to claim 11, wherein the instruction of triggering the state transition comprises at least one of:
an instruction of entering the low-power receiving state; and
an ultra-low power wake-up signal (LP-WUS).

15. The communication device according to claim 14, wherein in response to the terminal device transitioning from the normal receiving state to the low-power receiving state and/or receiving the instruction of entering the low-power receiving state, the terminal device controls at least one of:
an uplink and downlink pre-configured grant;
a channel state information (CSI) report;
a sounding reference signal (SRS);
a physical uplink control channel (PUCCH);
a power headroom report (PHR);
a secondary cell (SCell) state; and
a data inactivity timer;
the terminal device controlling the uplink and downlink pre-configured grant comprises at least one of:
suspending a configured grant (CG) type 1;
clearing the CG type 1;
clearing or deactivating a semi-persistent scheduling (SPS); and
clearing or deactivating a CG type 2;
the terminal device controlling the CSI report comprises at least one of:
suspending or clearing a periodic CSI report; and
suspending, clearing, or deactivating a semi-persistent CSI report;
the terminal device controlling the SRS comprises at least one of:
suspending or clearing a periodic SRS; and
suspending, clearing, or deactivating a semi-persistent SRS;
the terminal device controlling the PUCCH comprises:
suspending or clearing the PUCCH;
the terminal device controlling the PHR comprises:
stopping or suspending at least one of:
a PHR periodic timer;
a PHR prohibit timer; and
a maximum permissible exposure (MPE) prohibit timer;
the terminal device controlling the SCell state comprises:
deactivating a SCell;
the terminal device controlling the data inactivity timer comprises:
stopping the data inactivity timer.

16. The communication device according to claim 14, wherein in response to the terminal device transitioning from the low-power receiving state to the normal receiving state and/or receiving the LP-WUS, the terminal device controls at least one of:
an uplink and downlink pre-configured grant;
a CSI report;
a SRS;
a PUCCH;
a PHR;
a SCell state; and
a data inactivity timer;
the terminal device controlling the uplink and downlink pre-configured grant comprises:
initializing or recovering a suspended CG type 1; the suspended CG type 1 is a CG type 1 configured on a special cell (SpCell) and/or a CG type 1 configured on an activated Scell;
the terminal device controlling the CSI report comprises at least one of:
initializing or recovering a suspended periodic CSI report; and
initializing or recovering a suspended semi-persistent CSI report;
the terminal device controlling the SRS comprises at least one of:
initializing or recovering a suspended periodic SRS; and
initializing or recovering a suspended semi-persistent SRS;
the terminal device controlling the PUCCH comprises:
initializing or recovering a suspended PUCCH;
the terminal device controlling the PHR comprises:
triggering the PHR; and
recovering or starting at least one of:
a PHR periodic timer;
a PHR prohibit timer; and
an MPE prohibit timer;
the terminal device controlling the SCell state comprises:
activating all or a part of SCells;
the terminal device controlling the data inactivity timer comprises:
starting the data inactivity timer.

17. The communication device according to claim 16, wherein the terminal device activating all or a part of the SCells comprises:
the terminal device determining SCells transitioning from an activated state to a deactivated state during a latest state transition process of the terminal device; and
the terminal device activating determined SCells;
or,
the terminal device determining to activate all or a part of the SCells according to a first instruction.

18. A communication device, comprising:
a memory, configured to store a computer program; and
a processor, configured to call and perform the computer program stored in the memory, making a network device to execute:
sending an instruction of triggering a terminal device to perform a state transition; and
controlling at least one of a resource configuration and a timer.

19. The communication device according to claim 18, wherein the instruction of triggering a terminal device to perform a state transition comprises at least one of:
an instruction of entering the low-power receiving state; and
a LP-WUS.

20. The communication device according to claim 19, wherein the instruction of entering the low-power receiving state is configured to trigger the terminal device to transition from a normal receiving state to a low-power receiving state;
the LP-WUS is configured to trigger the terminal device to transition from a low-power receiving state to a normal receiving state.
